(19) United States
(12) Patent Application Publication
(10) Pub. No.: US 2018/0264907 A1
(43) Pub. Date: Sep. 20, 2018

(54) VIBRATION-SENSITIVE SUSPENSION SYSTEM AND CONTROL METHOD THEREOF

(71) Applicants: Hyundai Motor Company, Seoul (KR); Kia Motors Corporation, Seoul (KR)

(72) Inventor: Hee-Gon KANG, Anyang-si (KR)

(73) Assignees: Hyundai Motor Company, Seoul (KR); Kia Motors Corporation, Seoul (KR)

(21) Appl. No.: 15/858,422

(22) Filed: Dec. 29, 2017

(30) Foreign Application Priority Data
Mar. 15, 2017 (KR) 10-2017-0032414

(51) Int. Cl. B60G 17/0195; B60G 17/0165; B60G 17/018; B60G 17/06

(52) U.S. Cl. CPC B60G 17/0195; B60G 17/06; B60G 17/018; B60G 17/0165

(57) ABSTRACT

A vibration-sensitive suspension system may include a damping-force varying shock absorber, a detecting device detecting an acceleration signal, a storing device extracting a natural frequency from an excitation test of a vehicle, and storing the extracted natural frequency, and an ECU receiving the acceleration signal from the detecting device, extracting a frequency signal, and determining whether the extracted frequency matches the natural frequency, thus regulating a damping force of the shock absorber.

### CROSS-REFERENCE(S) TO RELATED APPLICATIONS

The present application claims priority to Korean Patent Application No. 10-2017-0032414, filed on Mar. 15, 2017 the entire contents of which is incorporated herein for all purposes by this reference.

### BACKGROUND OF THE INVENTION

### Field of the Invention

The present invention relates to a vibration-sensitive suspension system and a control method thereof; and, more particularly, to a vibration-sensitive suspension system and a control method thereof, which are intended to control a damping force when a specific frequency is inputted in a vehicle provided with an electronic controlled suspension, thus reducing an amplitude of an axle and preventing a brake from being inoperative.

### Description of Related Art

In general, a suspension system is a device that connects a device including a frame, a prime mover, a power transmission device and the like except for a vehicle body to an axle to which a wheel is attached, and includes a damper and a spring to absorb shocks resulting from an uneven road.

As illustrated in FIG. 1A, the axle which is subjected to a rotating force from an engine of a vehicle to drive the wheel and generate a braking force includes a knuckle 10, a hub bearing, a brake disk 40, a brake caliper 20 and the like

As illustrated in FIG. 1B, if a frequency of load inputted into the wheel in specific road unevenness and at a specific vehicle speed while the vehicle is running matches a natural frequency of the vehicle axle, the axle causes resonance and the amplitude instantaneously becomes excessive.

In the instant case, the vibration of the axle increases, so that relative motion between the brake disk 40 and the brake caliper 20 occurs. Furthermore, the brake disk 40 pushes the brake pad 30, so that the brake may not be operated properly when a braking pedal is pressed, due to the pushed pad 30.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vibration-sensitive suspension system and a control method thereof, which are intended to control a damping force of a shock absorber when a wheel input frequency in a vehicle provided with an electronic controlled suspension matches a predetermined natural frequency of an axle, thus reducing an amplitude of the axle and preventing a brake from being inoperative.

An exemplary embodiment of the present invention is directed to a vibration-sensitive suspension system including a damping-force varying shock absorber; a detecting device detecting an acceleration signal; a storing device extracting a natural frequency of a vehicle body or an axle from an excitation test result of a vehicle and storing the extracted natural frequency; and an engine control unit (ECU) receiving the acceleration signal from the detecting device, extracting a frequency signal, and determining whether the extracted frequency matches the natural frequency stored in the storing device, thus regulating a damping force of the shock absorber.

The detecting device may be a vehicle-body acceleration detector to sense an acceleration signal of a vehicle body or a wheel acceleration detector to sense an acceleration signal of a wheel.

The wheel acceleration detector may be mounted on a front wheel of the vehicle.

The vibration-sensitive suspension system may further include a mode switch having an automatic mode and a manual mode.

Various aspects of the present invention are directed to providing a method of controlling a vibration-sensitive suspension system including setting a natural frequency of a vehicle body or an axle; receiving an acceleration signal of a vehicle which is running; extracting a frequency signal from the received acceleration signal; determining whether the extracted frequency matches the natural frequency; and regulating a damping force of a damping-force varying shock absorber to inhibit an amplitude from being produced by a resonance in the vehicle body or the axle.

The setting of the natural frequency may include exciting the vehicle according to a frequency with a vehicle excitation tester to perform an excitation test; analyzing a test result from the excitation test and extracting the natural frequency of the vehicle body and the axle; and storing the extracted frequency of the vehicle body and the axle in a storing device.

The regulating of the damping force may simultaneously switch the damping force of each of the damping-force varying shock absorber into a hard mode.

At the regulating of the damping force, a control of the damping force may be completed after a predetermined time.

At the regulating of the damping force, a control of the damping force may be completed after moving a predetermined distance.

The regulating of the damping force of the damping-force varying shock absorber may switch an electronic controlled suspension into a manual mode.

In accordance with various aspects of the present invention, it is possible to regulate a damping force of a damping-force varying shock absorber to inhibit an amplitude from being generated by a resonance in a vehicle body or an axle, and an electronic controlled suspension is switched into a manual mode when it is expected that the resonance will be produced according to road and driving conditions or when the resonance is produced, thus preventing a brake from being inoperative.

In accordance with various aspects of the present invention, when a wheel input frequency in a vehicle provided with an electronic controlled suspension matches a predetermined natural frequency of an axle, the amplitude of the axle is reduced by controlling a damping force of a shock absorber, thus preventing a brake from being inoperative.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A and FIG. 1B are schematic views illustrating a state in which a brake is not operated when a resonance is produced in an axle.

FIG. 2 is a diagram illustrating a vibration-sensitive suspension system according to an exemplary embodiment of the present invention.

FIG. 3 is a flowchart illustrating a method of controlling a vibration-sensitive suspension system according to an exemplary embodiment of the present invention.

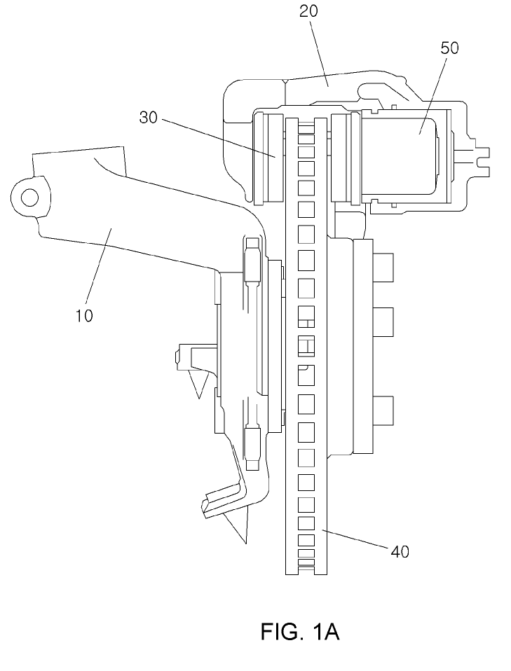

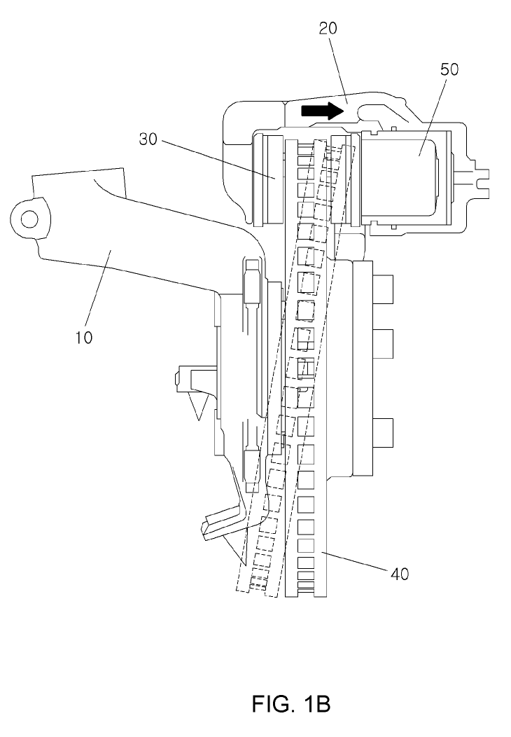

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The terms or words used in the description and the claims of the present invention should not be interpreted as being limited merely to common and dictionary meanings. On the other hand, they should be interpreted based on the meanings and concepts of the invention in keeping with the scope of the invention on the basis of the principle that the inventor(s) can appropriately define the terms in order to describe the invention in the best way. Thus, the invention may be embodied in different forms and should not be construed as limited to the exemplary embodiments set forth herein. Furthermore, it should be understood that the term, “first” or “second” is not intended to limit elements but is used to distinguish one element from another element.

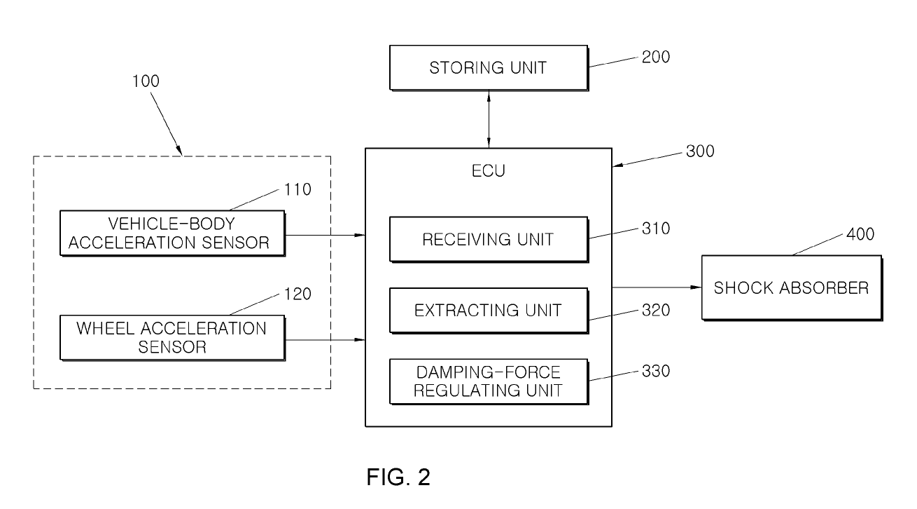

FIG. 2 is a diagram illustrating a vibration-sensitive suspension system according to an exemplary embodiment of the present invention.

Referring to FIG. 2, the vibration-sensitive suspension system according to an exemplary embodiment of the present invention includes a damping-force varying shock absorber 400, a detecting device 100 that detects an acceleration signal, a storing device 200 that extracts a natural frequency of a vehicle body or an axle from an excitation test result of a vehicle and stores the extracted natural frequency, and an ECU 300 that receives an acceleration signal from the detecting device 100, extracts a frequency signal, and determines whether the extracted frequency matches the natural frequency stored in the storing device, thus regulating a damping force of the shock absorber.

The damping-force varying shock absorber 400 has on a side thereof or therein a damping-force varying valve to appropriately regulate damping-force properties, and is configured to appropriately regulate the damping-force properties, thus enhancing a riding quality or handling performance according to road and driving conditions.

The damping-force varying shock absorber 400 is provided between a vehicle body or frame and each wheel, so that a damping force is regulated in a response to a control command from the ECU 300.

The vibration-sensitive suspension system may further include a mode switch as an electronic controlled suspension.

The mode switch may be switched into an automatic mode or a manual mode, or may automatically or manually switch the damping force of the electronic controlled suspension, according to a driver's intention.

That is, the vibration-sensitive suspension system according to an exemplary embodiment of the present invention is the electronic controlled suspension, which has the automatic mode that automatically regulates the damping force and the manual mode that manually regulates the damping force. When the electronic controlled suspension is switched into the manual mode, there occurs no phenomenon in which a brake is not operated according to road and driving conditions.

Thus, according to an exemplary embodiment of the present invention, to inhibit the amplitude from being generated by resonance in the vehicle body or the axle, the damping force of the damping-force varying shock absorber may be regulated. If it is expected that the resonance will be produced according to the road and driving conditions state or the resonance is produced, the electronic controlled suspension is switched into the manual mode, thus preventing the brake from being inoperative.

The detecting device 100 may be a vehicle-body acceleration detector 110 that detects an acceleration signal of the vehicle body or a wheel acceleration detector 120 that detects an acceleration signal of the wheel.

The vehicle-body acceleration detector 110 detects the acceleration of the vehicle body, particularly a vertical acceleration signal of the vehicle body and then transmits the detected vertical acceleration signal to a receiving device 310 of the ECU 300.

The wheel acceleration detector 120 detects the acceleration of the wheel, particularly a vertical acceleration signal of the wheel and then transmits the detected vertical acceleration signal to the receiving device 310 of the ECU 300.

The wheel acceleration detector 120 may be mounted on a front wheel of the vehicle. It is possible to mount the wheel acceleration detectors on front and rear wheels of the vehicle.

The storing device 200 extracts the natural frequency of the vehicle body or the axle from the excitation test result of the vehicle, and then stores the extracted natural frequency.

The ECU 300 receives the acceleration signal from the detecting device 100, extracts a frequency signal, and determines whether the extracted frequency matches the natural frequency stored in the storing device 200, thus regulating the damping force of the varying shock absorber 400.

The ECU 300 further includes a receiving device 310, an extracting device 320, and a damping-force regulating device 330.

The receiving device 310 receives the acceleration signal of the vehicle body or the wheel detected from the detecting device 100.

The extracting device 320 extracts a signal component of a resonant frequency domain from the acceleration signal of the vehicle body or wheel received by the receiving device 310. Here, a filter may be used to extract the signal component of the resonant frequency domain.

The damping-force regulating device 330 compares an intensity of the extracted signal component with the natural frequency of the vehicle body or the axle, which is previously stored in the storing device 200, and determines whether the extracted frequency matches the natural frequency, thus regulating the damping force of the damping-force varying shock absorber 400 to inhibit the amplitude from being produced by the resonance in the vehicle body or the axle.

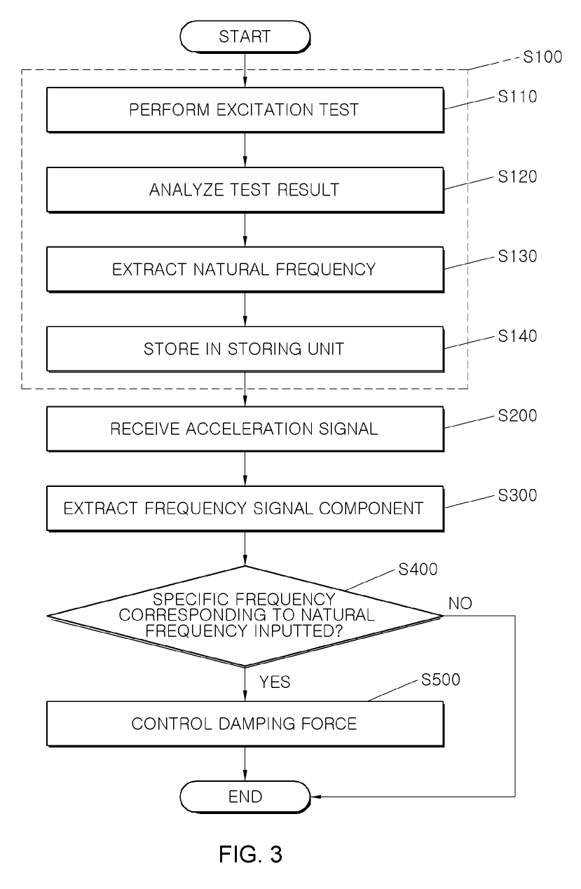

FIG. 3 is a flowchart illustrating a method of controlling a vibration-sensitive suspension system according to an exemplary embodiment of the present invention.

Referring to FIG. 3, the method of controlling the vibration-sensitive suspension system according to an exemplary embodiment of the present invention includes a step S100 of setting a natural frequency of a vehicle body or an axle, a step S200 of receiving an acceleration signal of a vehicle which is running, a step S300 of extracting a frequency signal from the received acceleration signal, a step S400 of determining whether the extracted frequency matches the natural frequency, and a step S500 of regulating a damping force of a damping-force varying shock absorber to inhibit the amplitude from being produced by the resonance in the vehicle body or the axle.

That is, the method of controlling the vibration-sensitive suspension system according to an exemplary embodiment of the present invention is performed as follows. First, an excitation test is performed to analyze the natural frequency of the vehicle body or the axle and store it in the storing device 200. Next, an acceleration signal is received from the vehicle-body acceleration detector 110 or the wheel acceleration detector 120 while the vehicle is running, and the frequency signal is extracted from the received acceleration signal. Subsequently, it is determined whether the extracted frequency matches the natural frequency, thus regulating the damping force of the damping-force varying shock absorber 400 to inhibit the amplitude from being produced by the resonance in the vehicle body or the axle.

Step S100 of setting the natural frequency includes a step S110 of exciting the vehicle according to the frequency with a vehicle excitation tester to perform the excitation test, steps S120 and S130 of analyzing a test result from the excitation test and extracting the natural frequency of the vehicle body and the axle, and a step S140 of storing the extracted frequency of the vehicle body and the axle in the storing device 200.

At step S300 of extracting the frequency signal, the extracting device 320 extracts the signal component of the resonant frequency domain from the acceleration signal of the vehicle body or the wheel, which is received by the receiving device 310. Here, a filter may be used to extract the signal component of the resonant frequency domain.

At step S400 of determining whether the extracted frequency matches the natural frequency, the damping-force regulating device 330 compares the intensity of the extracted signal component with the natural frequency of the vehicle body or the axle, which is previously stored in the storing device 200, and determines whether the extracted frequency matches the natural frequency.

At step S500 of regulating the damping force, the damping force of the damping-force varying shock absorber 400 may be regulated to inhibit the amplitude from being produced by the resonance in the vehicle body or the axle.

At step S500 of regulating the damping force, the damping force of the damping-force varying shock absorber may be simultaneously switched into a hard mode, for example.

Furthermore, at step S500 of regulating the damping force, the control of the damping force may be completed after a predetermined time or after moving a predetermined distance. The reason is because the vehicle may be braked after moving 100 or 200 meters, within 1 to 10 seconds when a braking operation is impossible even though the damping force is not controlled.

At step S500 of regulating the damping force of the damping-force varying shock absorber, the electronic controlled suspension may be switched into a manual mode.

That is, the vibration-sensitive suspension system according to an exemplary embodiment of the present invention is the electronic controlled suspension, which may have the automatic mode that automatically regulates the damping force and the manual mode that manually regulates the damping force. When the electronic controlled suspension is switched into the manual mode, there occurs no phenomenon in which a brake is not operated according to road and driving conditions.

Thus, according to an exemplary embodiment of the present invention, to inhibit the amplitude from being generated by resonance in the vehicle body or the axle, the damping force of the damping-force varying shock absorber may be regulated. When it is expected that the resonance will be produced according to the road and driving conditions state or when the resonance is produced, the electronic controlled suspension is switched into the manual mode, thus preventing the brake from being inoperative.

According to an exemplary embodiment of the present invention, when the wheel input frequency in the vehicle provided with the electronic controlled suspension matches a predetermined natural frequency of the axle, the amplitude of the axle is reduced by controlling the damping force of the shock absorber, thus preventing the brake from being inoperative.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings.

The exemplary embodiments were chosen and described to explain certain principles of the invention and their practical application, to enable others skilled in the art to make and utilize various exemplary embodiments of the present invention, as well as various alternatives and modifications thereof It is intended that the scope of the invention be defined by the Claims appended hereto and their equivalents.

What is claimed is:

1. A vibration-sensitive suspension system comprising:
a damping-force varying shock absorber;
a detecting device detecting an acceleration signal;
a storing device extracting a natural frequency from an excitation test of a vehicle, and storing the extracted natural frequency; and
an engine control unit (ECU) configured for receiving the acceleration signal from the detecting device, extracting a frequency signal, and determining whether the extracted frequency matches the natural frequency, thus regulating a damping force of the shock absorber.

2. The vibration-sensitive suspension system of claim 1, wherein the detecting device includes a vehicle-body acceleration detector to detect an acceleration signal of a vehicle body or a wheel acceleration detector to detect an acceleration signal of a wheel.

3. The vibration-sensitive suspension system of claim 2, wherein the wheel acceleration detector is mounted on a front wheel of the vehicle.

4. The vibration-sensitive suspension system of claim 1, further including:
a mode switch having an automatic mode and a manual mode.

5. A method of controlling a vibration-sensitive suspension system comprising:
setting a natural frequency of a vehicle body or an axle;
receiving an acceleration signal of a vehicle which is running;
extracting a frequency signal from the received acceleration signal;
determining whether the extracted frequency matches the natural frequency; and
regulating a damping force of a damping-force varying shock absorber to inhibit an amplitude from being produced by a resonance in the vehicle body or the axle.

6. The method of claim 5, wherein the setting of the natural frequency includes:
exciting the vehicle according to a frequency with a vehicle excitation tester to perform an excitation test;
analyzing a test result from the excitation test and extracting the natural frequency of the vehicle body and the axle; and
storing the extracted frequency of the vehicle body and the axle in a storing device.

7. The method of claim 5, wherein the regulating of the damping force switches the damping force of each of the damping-force varying shock absorber into a hard mode.

8. The method of claim 5, wherein, at the regulating of the damping force, a control of the damping force is completed after a predetermined time.

9. The method of claim 5, wherein, at the regulating of the damping force, a control of the damping force is completed after moving a predetermined distance.

10. The method of claim 5, wherein the regulating of the damping force of the damping-force varying shock absorber switches an electronic controlled suspension into a manual mode.
